(19) United States
(12) Patent Application Publication
(10) Pub. No.: US 2026/0205050 A1
(43) Pub. Date: Jul. 16, 2026

(54) 4 Way Solar Tilting System

(71) Applicant: Neil Kauppila, Montrose, CO (US)

(72) Inventor: Neil Kauppila, Montrose, CO (US)

(73) Assignee: Neil Kauppila, Montrose, CO (US)

(21) Appl. No.: 19/020,018

(22) Filed: Jan. 14, 2025

(51) Int. Cl. H02S 20/30; H02S 10/40

(52) U.S. Cl. CPC H02S 20/30; H02S 10/40

(57) ABSTRACT

This invention pertains to the technical field of mobile photovoltaic arrays. Solar systems that frequently change orientation often fail to utilize equatorial tilt effectively. This invention introduces a versatile tilting mechanism for solar arrays, with two orthogonal pivot axes at each corner enabling multi-directional tilt through innovative mechanical joints and structural members. This system is particularly advantageous for mobile applications such as vehicles, trailers, and boats, where orientation changes frequently. The design prioritizes cost-effectiveness, durability, and ease of use, making it suitable for a wide range of users.

### BACKGROUND

A common challenge for solar systems installed on mobile platforms is the inability to adjust the array's tilt to maximize power generation. Mobile vehicles often change orientation, resulting in suboptimal energy capture. Existing solutions typically use one or two axes of rotation, which are often cost-prohibitive and limited in versatility.

This invention addresses these limitations by introducing a multi-directional tilting mechanism capable of articulation about two orthogonal pivot axes at each corner enabling multi-directional tilt. Unlike prior art, which predominantly offers one-or two-axis tilt systems, this invention provides two additional degrees of freedom, enhancing parking flexibility and solar alignment. The economical design ensures affordability without compromising functionality.

The only prior art known in this field is the inventor's earlier design, developed in 2021 under the company “4 Way Solar.” This earlier system introduced the concept of a multi-directional tilting mechanism for mobile solar arrays. However, the provisional patent for this system expired, and significant design improvements have since been made. These include a quick-release fastening system for tool-free assembly, a locking feature to secure fasteners against vibrations, a machined-eyelet to reduce part count, and corrosion-resistant materials to ensure outdoor durability. These advancements form the foundation of the current invention.

### SUMMARY

The invention comprises mounting brackets for solar panels, mechanical joints enabling rotation about two orthogonal pivot axes at each corner, and structural members supporting the tilted configuration. These components are designed for quick assembly and secure operation, even in high-vibration environments. The primary application is for mobile platforms requiring flexible and durable solar systems, including recreational vehicles, trailers, boats, and other modules with power demands.

### TECHNICAL DRAWINGS DESCRIPTIONS

FIG. 1: Possible Tilting Configurations

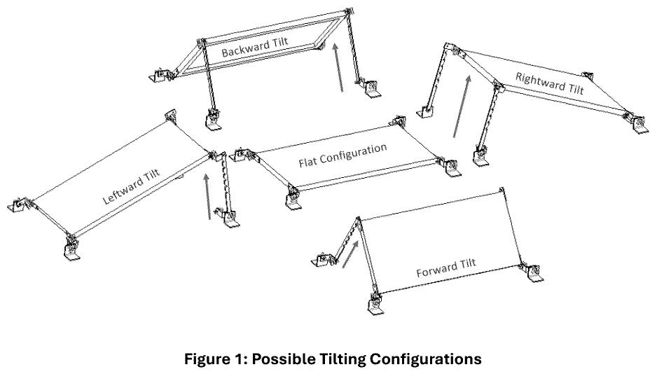

This drawing shows the 4 possible tilting configurations that are possible utilizing this invention. Flat configuration (stowed) is also shown in the center of the four configurations.

FIG. 2: Joint Design 1: Machined Eyelet and Brackets

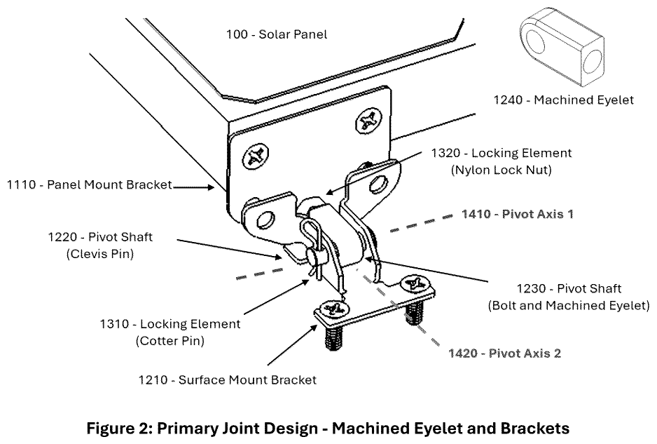

This drawing shows the primary embodiment covered by this invention. Two orthogonal axes of rotation (1410, 1420) are created at each corner by means of two distinct pivot shafts (1220,1230), in order to allow for solar panel (100) articulation.

Locking elements (1310, 1320) are also employed to prevent disengagement in a vibratory environment. Finally, sheet metal brackets are used to secure the mechanism to the panel (1110) and to the mounting surface (1210).

FIG. 3: Joint Design 2: Angle Brackets and Hand Knobs

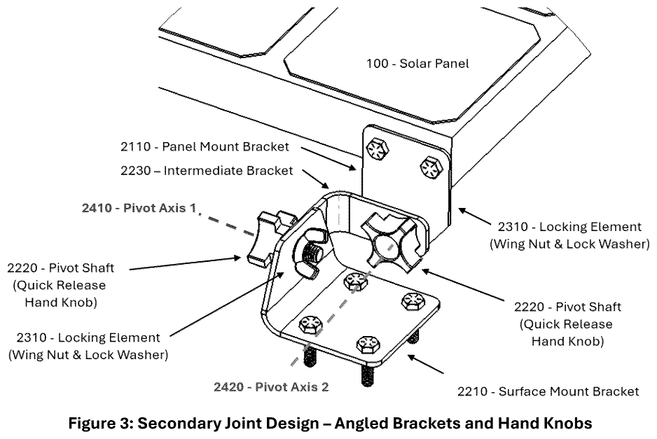

This drawing shows the secondary embodiment covered by this invention. The main difference in this design is the use of Quick Release hand knobs (2220), wing nuts and lock washers (2310), and an Intermediate Bracket (2230). The same two orthogonal axes of rotation (2410 and 2420) are created by similar but different means.

FIG. 4: Functional Drawing

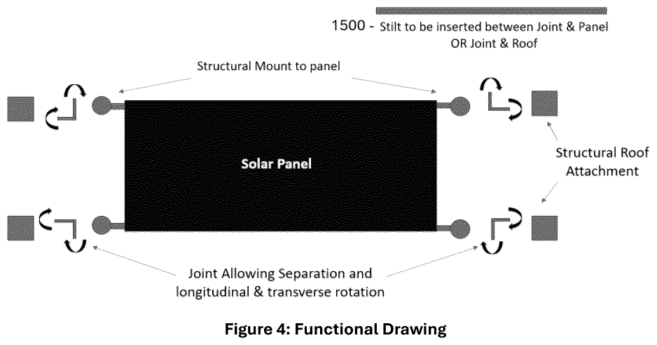

This drawing shows the functional requirements of this invention. 2 axes of rotation is required at each corner of the solar panel, in addition to a structural member to support the panel in the tilted position.

### DETAILED DESCRIPTION AND EMBODIMENTS

The system utilizes the following components:
Panel Mounting Brackets (1110): Attached to the solar panel at each of the 4 corners.
Pivot Shafts (1220, 1230): Allow for articulation about the two pivot axes (1410,1420)
Locking Elements (1310, 1320): Secure the assembly in a vibratory environment.
Surface Mounting Brackets(1210,2210): Securely attached to the mounting surface.
Structural Support Members (‘stilts’) (1500): selectively engageable to support the panel in a tilted orientation.

### General Operation

1. In the stowed configuration, all brackets are secured with locking fasteners.
2. To tilt the panel, remove two quick-release fasteners from opposite corners.
3. Lift the panel and insert structural stilts, securing them with locking fasteners.
4. To stow, remove the stilts and reattach the panel to the brackets.

### Additional Embodiments

Second Embodiment: Utilizes an intermediate sheet metal bracket (2230) in place of a machined eyelet (1240) to create the two pivot axes (2410,2420).

### Conclusion and Scope

This invention offers a practical, cost-effective solution for mobile solar applications. By enabling two orthogonal pivot axes at each corner, the system maximizes solar energy capture while maintaining affordability and ease of use. While the described embodiments illustrate potential configurations, they do not limit the invention's scope, which encompasses any system meeting the described functional requirements.

1. A solar panel tilting assembly configured for use on a mobile platform, comprising: four corner joint assemblies, each corner joint assembly comprising (a) a first pivot member defining a first rotational axis between a panel mounting bracket and a surface mounting bracket, and (b) a second pivot member defining a second rotational axis between the panel mounting bracket and the surface mounting bracket, the second rotational axis being orthogonal to the first rotational axis; the four corner joint assemblies collectively supporting a solar panel such that the panel is tiltable into at least four discrete orientations including north-tilt, south-tilt, east-tilt, and west-tilt solely by rotation about the first and second rotational axes at selected corners; and a vibration-resistant locking mechanism associated with at least one of the pivot members and configured to prevent unintended loosening or disengagement during motion of the mobile platform.

2. The assembly of Claim 1, wherein the first pivot member comprises a pivot shaft passing through aligned apertures of the panel mounting bracket.

3. The assembly of Claim 1, wherein the second pivot member comprises a pivot shaft passing through aligned apertures of the surface mounting bracket.

4. The assembly of Claim 1, wherein the assembly is formed from corrosion-resistant materials selected from the group consisting of aluminum alloys, coated steel, and stainless steel.

5. The assembly of Claim 1, wherein the solar panel is mounted to a mobile vessel.

6. The assembly of Claim 1, wherein the first and second rotational axes are mechanically independent such that rotation about one axis does not constrain rotation about the other axis.

7. The assembly of Claim 1, wherein each of the four corner joint assemblies is structurally identical to permit uniform tilt behavior in any direction.

8. The assembly of Claim 1, wherein the vibration-resistant locking mechanism comprises a nylon-insert lock nut, a detent pin, a spring-biased fastener, or a lock washer.

9. The assembly of Claim 1, wherein the surface mounting bracket is configured to conform to a curved surface of a recreational vehicle roof.

10. The assembly of Claim 1, further comprising one or more removable structural support members configured to engage the solar panel and the mobile platform to hold the solar panel in a selected tilted orientation.

1. A mechanism to tilt a solar panel in three or more distinct directions, comprising:
(a) one or more mechanical joints enabling rotation; (b) structural members supporting the panel; (c) quick-release fasteners securing the mechanism; and (d) locking elements preventing disengagement in vibratory environments.

2. The system of claim 1, wherein the mechanism includes: (a) a pivot joint allowing movement in horizontal and vertical planes.

3. The system of claim 1, wherein materials are corrosion-resistant and suitable for outdoor use.

4. The system of claim 1, wherein the solar array is mounted to a mobile vessel.
